(19) United States
(12) Patent Application Publication
(10) Pub. No.: US 2010/0275771 A1
(43) Pub. Date: Nov. 4, 2010

(54) Hydraulic System and Mobile Construction Machine

(75) Inventors: Frank Helbling, Sasbach (DE); Cyril Graebling, Colmar (FR)

Correspondence Address: DILWORTH & BARRESE, LLP, 1000 WOODBURY ROAD, SUITE 405, WOODBURY, NY, 11797, US

(73) Assignee: LIEBHERR-FRANCE SAS, Colmar Cedex (FR)

(21) Appl. No.: 12/769,147

(22) Filed: Apr. 28, 2010

(30) Foreign Application Priority Data
Apr. 29, 2009 (DE) UM202009006299.6

(51) Int. Cl. F15B 13/00

(52) U.S. Cl. 91/528

(57) ABSTRACT

The present invention relates to a hydraulic system having at least two piston-in-cylinder units, at least one equalization line for the pressure equalization between the piston-in-cylinder units and the control pistons, with one respective control piston being associated with a connection of a piston-in-cylinder unit and with at least one 2-way flow regulation valve with a check valve function being in communication with the at least one equalization line.

### BACKGROUND OF THE INVENTION

The present invention relates to a hydraulic system having at least two piston-in-cylinder units, an equalizing line for the pressure equalization between the piston-in-cylinder units and the control pistons, with one respective control piston being associated with a connection of a piston-in-cylinder unit.

Such hydraulic systems are used, for example, in mobile construction machinery, in particular in hydraulic excavators. Hydraulic excavators and other mobile construction machinery are also inter alia used for load lifting work. In this case, burst pipe safety valves are prescribed for safety reasons which allow the controlled lowering of the load on the bursting of a hose or of a pipeline.

Two parallel piston-in-cylinder units are typically used for the boom in an excavator, also for the stick with larger machines. An equalization line is installed to ensure a uniform load bearing capacity of the two piston-in-cylinder units.

In accordance with ISO 8643, the oil loss on a bursting of this equalization line may not amount to more than 10 l/min per cylinder. To meet this demand, in known systems (cf. also FIG. 1), nozzles with the reference numerals 40, 42 are used which limit the throughflow quantity to 10 l/min at a maximum pressure (at the drive side).

This system allows a pressure equalization statically. To ensure a symmetrical load holding in dynamic operation, it is necessary that the control pistons of the system, provided with the reference numerals 30, 32 in FIG. 1, have the same opening cross-section at all times, which is not simple to ensure in practice due to tolerances and disturbance variables.

The hydrodynamic jet force ƒ(\sqrt{Δp};Q) inter alia counts as a disturbance variable which has the result that the control piston releases less cross-section with the same desired value and thus bears more load. This means that as soon as the pressures are not equalized, the load is only borne by one cylinder.

A sufficient equalization amounts is already required between the cylinders at a low pressure difference for safe dynamic operation. Due to the throughflow behavior of nozzles ƒ(\sqrt{Δp};A), no sufficient equalization can take place to compensate the influence of the tolerances at a low pressure difference, above all with larger machinery. The standard would no longer be satisfied by the installation of a nozzle with a larger restrictor cross-section.

### SUMMARY OF THE INVENTION

It is therefore the object of the present invention to further develop a hydraulic system of the initially named kind in an advantageous manner, in particular such that a sufficient equalization quantity of hydraulic liquid can always be provided for the compensation of pressure differences, such that the system has a simple and safe structure and the relevant standards are still satisfied.

This object herein is achieved in accordance with the invention by a hydraulic system having the features herein. Provision is accordingly made that a hydraulic system has at least two piston-in-cylinder units, at least one equalization line for the pressure equalization between the piston-in-cylinder units and the control pistons, with one respective control piston being associated with a connection of a piston-in-cylinder unit and with at least one 2-way flow regulation valve with a check valve function being in communication with the at least one equalization line.

The advantage thereby results that a constant equalization quantity can already be achieved with a small pressure difference, said equalization quantity being larger by a factor of 5-10 at the decisive moment, that is, on an occurrence of pressure differences, than with a solution which only has one nozzle like the previously known systems. It is at the same time ensured that the maximum oil loss on the bursting of the equalization line no longer exceeds more than 10 l/min per cylinder and the corresponding standard is thus satisfied. It is, for example, conceivable that a 2-way flow regulation valve with a check function in both directions is formed in an integrated construction and is arranged in the equalization line. It is also possible that such a 2-way flow regulation valve in an integrated construction also includes the equalization line.

Provision can furthermore be made that the 2-way flow regulation valve connects the equalization line, a control piston and a connection of the piston-in-cylinder unit. This arrangement advantageously allows a safe pressure equalization in dynamic operation with a simultaneously simple construction.

It is furthermore possible that a 2-way flow regulation valve is associated with each piston-in-cylinder unit. The advantage thereby results that previously used hydraulic systems can be retrofitted since the 2-way flow regulation valves can advantageously be used instead of the previously used restrictors. It is further thereby possible to create a symmetrical design of the hydraulic system. A symmetrical design advantageously facilitates a symmetrical load distribution in dynamic operation.

It is furthermore conceivable that the 2-way flow regulation valves are each arranged at the end side of the equalization line.

Provision can furthermore be made that the 2-way flow control valve has two parallel fluid guides, with a first restrictor element with an adjustable diameter being provided in a first fluid guide and/or with a check element and a second restrictor element being arranged in series in a second fluid guide. The check element can be a check valve, for example. The check element is in this respect preferably a check element made such that it only triggers at a specific limit pressure or an abrupt pressure drop.

It is preferred if the second restrictor element is a nozzle. Provision can, however, likewise equally be made that the second restrictor element is a restrictor valve.

It is furthermore possible that the 2-way flow regulation valve is arranged integrated in a housing and/or in an intermediate plate. It is thereby possible to create a compact construction of the hydraulic system. Such an integrated construction furthermore allows protection against environmental conditions such are not uncommon with mobile construction machinery, for example. The housing can also be a previously used housing of a conventional burst pipe safety valve.

Provision can moreover be made that the 2-way flow regulation valve is arranged in a line branching off from the line connecting the control pistons and the connection of the piston-in-cylinder unit and connects this branching line to an end of the equalization line.

It is preferred if the piston-in-cylinder units are made in the same construction.

Provision can further advantageously be made that the piston-in-cylinder unit has a cylindrical piston space and a ring space, with the connection of the piston space being connected to a connection of the 2-way flow regulation valve.

It can furthermore be of advantage if the 2-way flow regulation valves are made in the same construction.

The invention furthermore relates to a mobile construction machine having the features herein. Provision is accordingly made that a mobile construction machine has at least one hydraulic system in accordance with these features.

It is in particular of advantage if the mobile construction machine is an excavator.

### BRIEF DESCRIPTION OF THE DRAWINGS

Further details and advantages will now be explained with reference to an embodiment shown in more detail in the drawing.

There are shown:

FIG. 1: a schematic representation of a known hydraulic system; and

FIG. 2: a schematic representation of an embodiment in accordance with the invention of a hydraulic system.

### DESCRIPTION OF THE PREFERRED EMBODIMENTS

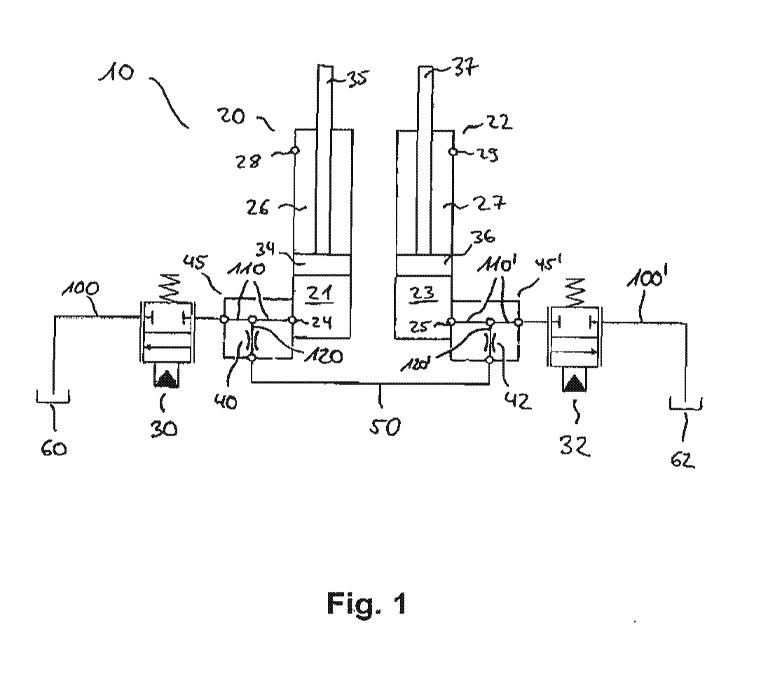

FIG. 1 shows, in a schematic representation, a known hydraulic system 10 for a mobile construction machine such as a hydraulic excavator, which is not shown in any more detail. The hydraulic system 10 is in this respect of a substantially symmetrical structure and has two piston-in-cylinder units 20, 22 which are connected in parallel and are made in the same construction.

The piston-in-cylinder units 20, 22 have cylindrical piston spaces 21, 23 which are in fluid communication with the further components of the hydraulic system 10 via connections 24, 25. The piston 34, 36 of the piston-in-cylinder unit 20, 22 furthermore has a piston rod 35, 37 which can be moved out by increasing the volume or the pressure in the piston space 21, 23.

To move in the piston 34, 36 or the piston rod 35, 37 of the piston-in-cylinder units 20, 22, the volume in the ring space 26, 27 is increased, for which purpose fluid is supplied via the connections 28, 29 of the ring spaces 26, 27 while the volume in the piston space 21, 23 is reduced accordingly.

To move the piston rods 35, 37 of the piston-in-cylinder units 20, 22 out dynamically in a uniform manner, a line 120 is provided which branches off from the line 110, 110′ connected to the connections 24, 25 and which has a restrictor element 40. The components of restrictor element 40, line 110 and line 120 or restrictor element 42 and lines 110′ and 120′ can advantageously each be combined to form a burst pipe safety valve 45, 45′. The restrictor elements 40, 42 bound the maximum throughflow to 10 l/min so that a maximum of 10 l/min of hydraulic fluid can be discharged per piston-in-cylinder unit 20, 22 in the event of a rupture of the line 50. The equalization line 50 is in this case respectively connected to the burst pipe safety valves 45, 45′ or to the restrictors 40, 42.

Hydraulic fluid is pumped from the reservoir 60, 62 via the hydraulic lines 100 or 100′ to the piston spaces 21, 23 to move out the piston rods 35, 37. Before the hydraulic fluid enters via the connections 24, 25 of the piston spaces 21, 23, the hydraulic fluid first flows through the control pistons 30, 32 which set their throughflow cross-section with reference to the preset desired value, e.g. for the pressure to be applied against the pistons 34, 36.

After the control piston 30, 32, the hydraulic fluid flows through the burst pipe safety valves 45, 45′ which are made in the same construction.

As already stated above, such an embodiment of the known hydraulic system does not allow any sufficient compensation of pressure differences in dynamic operation with a simultaneous satisfaction of the standards for oil loss on the bursting of the equalization line 50, according to which no more than 10 l/min oil may be discharged per piston-in-cylinder unit 20, 22.

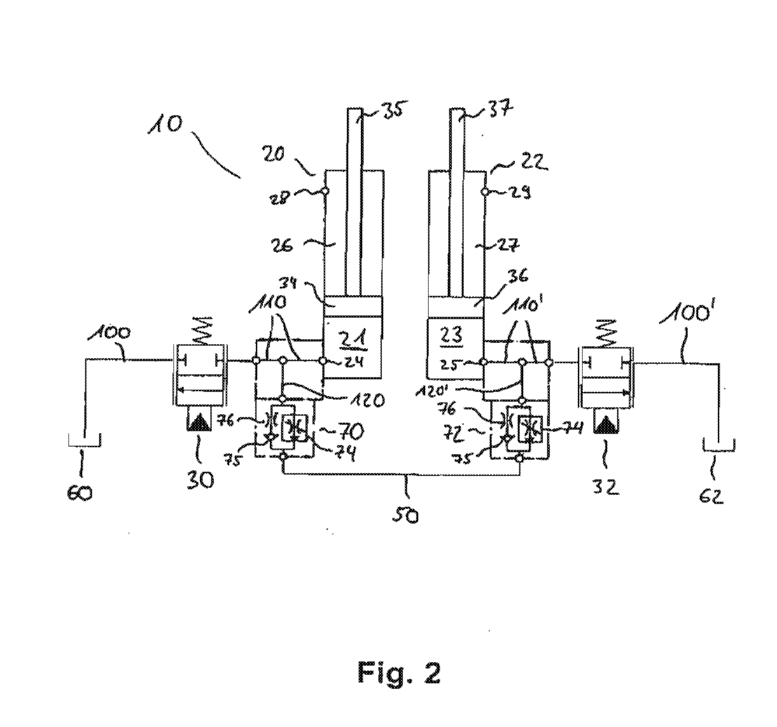

An embodiment in accordance with the invention of a hydraulic system 10 for a mobile construction machine such as a hydraulic excavator is shown in FIG. 2; this embodiment on the one hand allows a highly dynamic equalization of hydraulic fluid via the equalization lines 60, for example also with a slightly different cross-section of the control pistons 30, 32, with the standard at the same time still being satisfied, according to which a maximum of 10 l/min of hydraulic fluid may be discharged per piston-on-cylinder unit on a bursting of the equalization line so that the load raised indirectly by the moved out piston-in-cylinder units 20, 22 is slowly lowered.

In this respect, the embodiment shown in FIG. 2 is substantially of comparable structure as the hydraulic system 10 shown in FIG. 1. Comparable components are accordingly provided with the same reference numerals. Only the previously known burst pipe safety valve 45, 45′ was replaced by a 2-way flow regulation valve 70, 72. The 2-way flow regulation valve 70, 72 is in this respect in each case arranged at the end side in the equalization line and is connected via the line 120 or 120′ to the line 110, 110′ leading to the connection 24.

In the event that, for example, the control piston 30 should have a larger cross-section than the control piston 32 arranged at the other side, the hereby higher pressure, which would normally act on the piston 34, is compensated via the equalization line 50 or, in the case of bursting, a restricted discharge of hydraulic fluid such as hydraulic oil is made possible.

A part of the fluid coming from the control piston 30 branches off via the line 120 into the 2-way flow regulation valve 70 which on the one hand has two fluid guide paths connected in parallel.

In this respect, a restrictor element 74 with an adjustable opening cross-section is provided in a first fluid guide path of the 2-way flow regulation valve 70. A restrictor element 76 and, downstream thereof, a check valve 75 are arranged in the other fluid guide.

The 2-way flow regulation valve 72 is in this respect in the same construction of the 2-way flow regulation valve 70.

On a bursting of the line 50, the check valves 75 prevent more than 10 l/min of hydraulic fluid from being discharged per piston-in-cylinder unit 20, 22 so that the pistons 34, 36 move in evenly and slowly. In this case, the second fluid guides with the restrictor element 76 are each blocked via the restrictor element 75 so that a fluid discharge can only take place via the first restrictor element 74 having the variable diameter. In such a case, for example, it is ensured via a controller or regulator, not shown in any more detail, that the restrictor element 74 only has an opening cross-section which allows a maximum throughflow of 10 l/min.

Provision is advantageously made that a cross-section increase in the first restrictor element 74 having a variable diameter is only made possible by a direct control in a case in which an equalization requirement is recognized, that is, for example, only on the moving out of the piston-in-cylinder units 20, 22, with different opening cross-sections of the control pistons 30, 32 playing a role, so that a highly dynamic control via the equalization line 50 can take place.

After the moving out has taken place, a reset back into the zero position takes place, that is, the diameter of the restrictor element 74 again allows a maximum throughflow of 10 l/min. It is hereby ensured that an increased throughflow is only possible on an equalization, whereas in another respect throughflow quantities are only possible through the restricted opening cross-section of the restrictor element 74 which correspond to the standard so that the oil loss no longer amounts to more than 10 l/min per piston-in-cylinder unit 20, 22 on a bursting of the compensation line 50.

On a recognized bursting of the equalization line 50, for instance by a recognized abrupt pressure drop in the region of the equalization line 50, the restrictor elements 74 are reset to the zero position, if not already done, preferably automatically.

The restrictor elements 74 can in this respect be self-resetting, i.e. a separate activation has to take place for an enlarged diameter. Such an activation can then be reversed at the latest in a recognized bursting case so that the restrictor elements 74 automatically reset themselves to a diameter which allows a maximum throughflow of 10 l/min.

1. A hydraulic system (10) having at least two piston-in-cylinder units (20, 22), at least one equalization line (50) for the pressure equalization between the piston-in-cylinder units (20, 22) and control pistons (30, 32), wherein
one respective control piston (30, 32) is arranged in a connection (24, 25) of a piston-in-cylinder unit (20, 22), and
at least one 2-way flow regulation valve (70, 72) having a check valve function is in communication with the at least one equalization line (50).

2. A hydraulic system (10) in accordance with claim 1, wherein the 2-way flow regulation valve (70, 72) connects the equalization line (50), a control piston (30, 32) and a connection of the piston-in-cylinder unit (24, 25).

3. A hydraulic system (10) in accordance with claim 1, wherein at least one 2-way flow regulation valve (70, 72) is associated with each piston-in-cylinder unit (20, 22).

4. A hydraulic system (10) in accordance with claim 3, wherein the 2-way flow regulation valves (70, 72) are each arranged at the end side of the equalization line (50).

5. A hydraulic system (10) in accordance with claim 1, wherein the 2-way flow regulation valve (70, 72) has two parallel fluid guides, with a first restrictor element (74) having a settable diameter being provided in a first fluid guide and/or with a check element (75) and a second restrictor element (76) being arranged in series in a second fluid guide.

6. A hydraulic system (10) in accordance with claim 5, wherein the second restrictor element (76) is a nozzle.

7. A hydraulic system (10) in accordance with claim 1, wherein the 2-way flow regulation valve (70, 72) is arranged integrated in a housing and/or in an intermediate plate.

8. A hydraulic system (10) in accordance with claim 1, wherein the two-way flow regulation valve (70, 72) is arranged in a line (120, 120′) branching off from the line (110, 110′) connecting control pistons (30, 32) and the connection (24, 25) of the piston-in-cylinder unit (20, 22) and connects this branching line (120, 120′) to an end of the equalization line (50).

9. A hydraulic system (10) in accordance with claim 1, wherein the piston-in-cylinder units (20, 22) are made in the same construction.

10. A hydraulic system (10) in accordance with claim 1, wherein the piston-in-cylinder unit (20, 22) has a cylindrical piston space (21, 23) and a ring space (26, 27), with the connection of the piston space (21, 23) being connected to a connection of the 2-way flow regulation valve (70, 72).

11. A hydraulic system (10) in accordance with claim 1, wherein the 2-way flow regulations valves (70, 72) are made in the same construction.

12. A mobile construction machine having at least one hydraulic system (10) in accordance with claim 1.

13. A mobile construction machine in accordance with claim 12, wherein the mobile construction machine is an excavator.

14. A hydraulic system (10) in accordance with claim 2, wherein at least one 2-way flow regulation valve (70, 72) is associated with each piston-in-cylinder unit (20, 22).

15. A hydraulic system (10) in accordance with claim 14, wherein the 2-way flow regulation valves (70, 72) are each arranged at the end side of the equalization line (50).

16. A hydraulic system (10) in accordance with claim 15, wherein the 2-way flow regulation valve (70, 72) has two parallel fluid guides, with a first restrictor element (74) having a settable diameter being provided in a first fluid guide and/or with a check element (75) and a second restrictor element (76) being arranged in series in a second fluid guide.

17. A hydraulic system (10) in accordance with claim 14, wherein the 2-way flow regulation valve (70, 72) has two parallel fluid guides, with a first restrictor element (74) having a settable diameter being provided in a first fluid guide and/or with a check element (75) and a second restrictor element (76) being arranged in series in a second fluid guide.

18. A hydraulic system (10) in accordance with claim 4, wherein the 2-way flow regulation valve (70, 72) has two parallel fluid guides, with a first restrictor element (74) having a settable diameter being provided in a first fluid guide and/or with a check element (75) and a second restrictor element (76) being arranged in series in a second fluid guide.

19. A hydraulic system (10) in accordance with claim 3, wherein the 2-way flow regulation valve (70, 72) has two parallel fluid guides, with a first restrictor element (74) having a settable diameter being provided in a first fluid guide and/or with a check element (75) and a second restrictor element (76) being arranged in series in a second fluid guide.

20. A hydraulic system (10) in accordance with claim 2, wherein the 2-way flow regulation valve (70, 72) has two parallel fluid guides, with a first restrictor element (74) having a settable diameter being provided in a first fluid guide and/or with a check element (75) and a second restrictor element (76) being arranged in series in a second fluid guide.
